(19) United States
(12) Patent Application Publication
(10) Pub. No.: US 2005/0107996 A1
(43) Pub. Date: May 19, 2005

(54) Human skin impedance model representing a skin impedance response at high frequency

(76) Inventors: Woo-young Jang, Seoul (KR); Jin-ho Cho, Daegu-si (KR); Sang-hoon Shin, Seongnam-si (KR); Jeong-woo Lee, Daegu-si (KR)

Correspondence Address: LEE & STERBA, P.C., Suite 2000, 1101 Wilson Boulevard, Arlington, VA, 22209, US

(21) Appl. No.: 10/857,023

(22) Filed: Jun. 1, 2004

(30) Foreign Application Priority Data
Nov. 17, 2003 (KR) 2003-81101

(51) Int. Cl. G06G 7/48

(52) U.S. Cl. 703/11

(57) ABSTRACT

A skin impedance model of a predetermined part of a living body, which is an object to be measured, wherein the skin impedance model is estimated by providing a predetermined current between two ends of the predetermined part and measuring a voltage between the two ends, the model including a first area having a first resistor and a first constant phase element (CPE) connected in parallel, a second area having a second resistor and a second CPE connected in parallel, and a third resistor serially connected to the parallel connection of the second resistor and the second CPE, and a third area having a fourth resistor and a third CPE connected in parallel, wherein the second area and the third area are connected in parallel and are serially connected to the first area through a fifth resistor.

### BACKGROUND OF THE INVENTION

1. Field of the Invention

The present invention relates to an analysis of constituents of a body.

More particularly, the present invention relates to a human skin impedance model representing a skin impedance response in a high frequency band.

2. Description of the Related Art

By measuring a body electric impedance (hereinafter referred to as “impedance”) in a human body, a condition of skin may be estimated, an amount of body fat may be measured, a degree of medicine penetration on skin may be measured, or a response of skin to stimulation may be examined. FIG. 1 is a diagram for explaining a structure of a cell of a living body using an equivalent electric circuit. Referring to FIG. 1, due to variations in a shape and size of each cell, it may be seen that when each cell is expressed as an RC equivalent circuit, there is a slight difference among time constants (RC). More specifically, a first cell may have first time constants R1 and C1, a second cell may have second time constants R2 and C2, etc.

FIG. 2 is a diagram showing a conventional skin impedance model proposed by Cole. FIG. 3 is a diagram showing a locus of living body impedance represented on a complex impedance locus by the Cole impedance model. When a frequency is low, the impedance is located on R₀ on a complex impedance plane, and as the angular frequency (ω) increases, the impedance traces a semicircular locus. Finally, at a high frequency, the impedance converges on R∞.

The Cole impedance model uses a device, called a constant phase element (CPE), together with resistors. The CPE is a device having a characteristic in a middle between a resistor and a capacitor, and can be expressed as the following equation 1:
Z_{CPE}=k(jω)^{-α} (1)
where k denotes the amplitude of the constant phase element (CPE) at angular frequency ω=1 rad/s and a denotes a property between a property of a resistor and a property of a capacitor, e.g., 0.5-1 in the case of human skin.

A formula for the Cole model including the CPE device can be expressed as the following equation 2:

$$Z = {R}_{∞} + \frac{{R}_{0} - {R}_{∞}}{1 + ( {R}_{0} - {R}_{∞} ) {( {Z}_{CPE} )}^{- 1}} = {R}_{∞} + \frac{{R}_{0} - {R}_{∞}}{1 + \frac{{R}_{0} - {R}_{∞}}{k} {( j ω )}^{α}} \qquad ( 2 )$$

Equation 2 is used as a basic model for living body impedance.

If a result of a simulation of the impedance values from 1 Hz to 10 kHz, after appropriate parameters for the Cole impedance model are set, is represented on a complex impedance plane, the impedance locus as shown in FIG. 4 is obtained.

Since the impedance converges on R∞ at frequencies of 10 kHz or above, it is difficult to represent the impedance data on a complex impedance plane. In order to observe skin impedance characteristics at a high frequency band, e.g., over tens of kHz, the data can be represented on a complex admittance plane. If data from 1 Hz to 10 kHz are represented on a complex admittance plane, a graph similar to a straight line as shown in FIG. 5 is obtained, which does not form a complete semi-circular locus.

If skin impedance is represented on a complex admittance plane after simulating up to 2 MHz using the Cole impedance model, a semicircle locus as shown in FIG. 6 is obtained. Accordingly, in order to observe the characteristics of skin impedance at a high frequency area, measured data or simulation results should be represented on a complex admittance plane.

Among research on living body impedance, research on the impedance characteristics of skin, which is a specific part of a living body, is also being actively conducted. Among them, another conventional skin impedance model proposed by Kontturi, in which the skin impedance is modeled as electric devices, is shown in FIG. 7. The skin impedance model of FIG. 7 can be expressed as the following equation 3:

$${Z}_{Kontturi} = \frac{{kR}_{1} {{R}_{2} ( j ω )}^{- α} + kL ( {R}_{1} + {R}_{2} ) {( j ω )}^{1 - α}}{{R}_{1} {R}_{2} + j ω L ( {R}_{1} + {R}_{2} ) + {kR}_{2} j {ω}^{- α} + {kL ( j ω )}^{1 - α}} \qquad ( 3 )$$

As described above, when measured skin impedance data are represented on a complex impedance plane, the locus in a low frequency area does not form a complete semicircle but a round locus with an end of the locus partially opened. To solve this problem, Kontturi improved the characteristics of the skin impedance response by adding resistances and inductance to the existing Cole impedance model.

Since a maximum value of the measured frequency used in the Kontturi skin impedance model is 10 kHz, characteristics of skin impedance at higher frequencies are not considered.

A result of a simulation using the Kontturi skin impedance model represented on a complex impedance plane is shown in FIG. 8. The graph of FIG. 8 does not show a complete locus but shows a shape in which the low frequency area is partially opened. Accordingly, the Kontturi skin impedance model accurately represents the skin impedance response at a low frequency area.

However, if the response to 2 MHz is obtained through simulation, it is represented on a complex impedance plane, as in FIG. 8, such that the characteristics at the high frequency area cannot be identified. If the simulation result is represented on a complex admittance plane, a graph similar to a straight line as shown in FIG. 9 is obtained.

Actually, if in order to identify the frequency response of skin, skin impedance data up to 2 MHz are measured and represented on a complex admittance plane, it is shown as in FIG. 10 that admittance increases in a high frequency band of tens of MHz.

When FIGS. 9 and 10 are compared, it may be seen that the Kontturi impedance model is also unable to accurately represent the skin response at a high frequency band.

### SUMMARY OF THE INVENTION

The present invention provides a skin impedance model representing characteristics of a skin response at a high frequency band, e.g., on the order of megahertz (MHz).

According to a first embodiment of the present invention, there is provided a skin impedance model of a predetermined part of a living body, which is an object to be measured, wherein the skin impedance model is estimated by providing a predetermined current between two ends of the predetermined part and measuring a voltage between the two ends, the model including a first area having a first resistor and a first constant phase element (CPE) connected in parallel, a second area having a second resistor and a second CPE connected in parallel, and a third resistor serially connected to the parallel connection of the second resistor and the second CPE, and a third area having a fourth resistor and a third CPE connected in parallel, wherein the second area and the third area are connected in parallel and are serially connected to the first area through a fifth resistor.

Preferably, the first area represents an outer skin impedance of the predetermined part. Preferably, the second area represents an impedance of a membrane and an intercellular fluid in corium constituents of the skin of the predetermined part. Preferably, the third area represents an impedance of an intercellular fluid in corium constituents of the skin of the predetermined part.

According to a second embodiment of the present invention, there is provided a skin impedance model of a predetermined part of a living body, which is an object to be measured, wherein the skin impedance model is estimated by providing a predetermined current between two ends of the predetermined part and measuring a voltage between the two ends, the model including a first area having a first resistor and a first constant phase element (CPE) connected in parallel, a second area having a second resistor and a second CPE connected in parallel, and a third resistor serially connected to the parallel connection of the second resistor and the second CPE, and a third area having a fourth resistor and a third CPE connected in parallel, wherein the second area and the third area are connected in parallel and are serially connected to the first area.

According to a third embodiment of the present invention, there is provided a skin impedance model of a predetermined part of a living body which is an object to be measured, wherein the skin impedance model is estimated by providing a predetermined current between two ends of the predetermined part and measuring a voltage between the two ends, the model including a first area having a first resistor and a first constant phase element (CPE) connected in parallel, a second area having a second resistor and a second CPE connected in parallel, and a third resistor serially connected to the parallel connection of the second resistor and the second CPE, and a third area having a third CPE, wherein the second area and the third area are connected in parallel and are serially connected to the first area.

More generally, there may be provided a skin impedance model of a predetermined part of a living body, which is an object to be measured, wherein the skin impedance model is estimated by providing a predetermined current between two ends of the predetermined part and measuring a voltage between the two ends, the model including a first area representing an outer skin impedance of the predetermined part, a second area representing an impedance of a membrane and an intercellular fluid in corium constituents of the skin of the predetermined part, and a third area representing an impedance of an intercellular fluid in corium constituents of the skin of the predetermined part, wherein the second area and third area are connected in parallel and are serially connected to the first area.

In the first embodiment of the present invention, the first area may have a first resistor and a first constant phase element (CPE) connected in parallel, the second area may have a second resistor and a second CPE connected in parallel, and a third resistor serially connected to the parallel connection of the second resistor and the second CPE, and the third area may have a fourth resistor and a third CPE connected in parallel, and wherein the second area and the third area may be serially connected to the first area through a fifth resistor.

In the second embodiment of the present invention, the first area may have a first resistor and a first constant phase element (CPE) connected in parallel, the second area may have a second resistor and a second CPE connected in parallel, and a third resistor serially connected to the parallel connection of the second resistor and the second CPE, and the third area may have a fourth resistor and a third CPE connected in parallel.

In the third embodiment of the present invention, the first area may have a first resistor and a first constant phase element (CPE) connected in parallel, the second area may have a second resistor and a second CPE connected in parallel, and a third resistor serially connected to the parallel connection of the second resistor and the second CPE, and the third area may have a third CPE.

In any of the above-described embodiments of the present invention, the skin impedance model may be obtained from data measured in the predetermined part using a 3-electrode method. Further, the skin impedance model may be expressed as:

$$\begin{matrix}Z = \frac{{R}_{1} {{k}_{1} ( j ω )}^{- α1}}{{R}_{1} + {{k}_{1} ( j ω )}^{- α1}} + \\ \frac{{R}_{2} {R}_{3} {R}_{4} {{k}_{2} ( j ω )}^{- α2} + {R}_{2} ( {R}_{3} + {R}_{4} ) {k}_{2} {{k}_{3} ( j ω )}^{- ( α2 + α3 )}}{\begin{matrix}{R}_{2} {R}_{3} {R}_{4} + ( {R}_{2} {R}_{3} + {R}_{3} {R}_{4} ) {{k}_{2} ( j ω )}^{- α 2} + \\ {R}_{2} ( {R}_{3} + {R}_{4} ) {k}_{2} {{k}_{3} ( j ω )}^{- α 3} + ( {R}_{2} + {R}_{3} + {R}_{4} ) {k}_{2} {{k}_{3} ( j ω )}^{- ( α2 + α3 )}\end{matrix}} .\end{matrix}$$

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 is a diagram for explaining a structure of a cell of a living body using equivalent circuit diagrams;

FIG. 2 is a diagram showing a conventional skin impedance model proposed by Cole;

FIG. 3 is a diagram showing a locus of living body impedance represented on a complex impedance locus by the Cole impedance model;

FIG. 4 is a diagram showing a result of a simulation of impedance values from 1 Hz to 10 kHz using the Cole impedance model, represented on a complex impedance plane;

FIG. 5 is a diagram showing data from 1 Hz to 10 kHz obtained using the Cole impedance model, represented on a complex admittance plane;

FIG. 6 is a diagram showing a result of a simulation up to a 2 MHz band using the Cole impedance model, represented on a complex admittance plane;

FIG. 7 is a diagram showing another conventional skin impedance model proposed by Kontturi;

FIG. 8 is a diagram showing a result of a simulation using the Kontturi skin impedance model, represented on a complex impedance plane;

FIG. 9 is a diagram showing a result of a simulation from 1 Hz to 2 MHz using the Kontturi skin impedance model, represented on a complex admittance plane;

FIG. 10 is a diagram of skin impedance data from 1 Hz to 2 MHz measured in order to test a frequency response of skin, represented on a complex admittance plane;

FIG. 11 is a diagram illustrating a skin impedance model according to a first embodiment of the present invention;

FIG. 12 is a diagram illustrating a 3-electrode method for measuring a skin impedance;

FIG. 13 is a table showing skin impedance data measured by the 3-electrode method;

FIG. 14 is a diagram illustrating a skin impedance model according to a second embodiment of the present invention; and

FIG. 15 is a diagram illustrating a skin impedance model according to a third embodiment of the present invention.

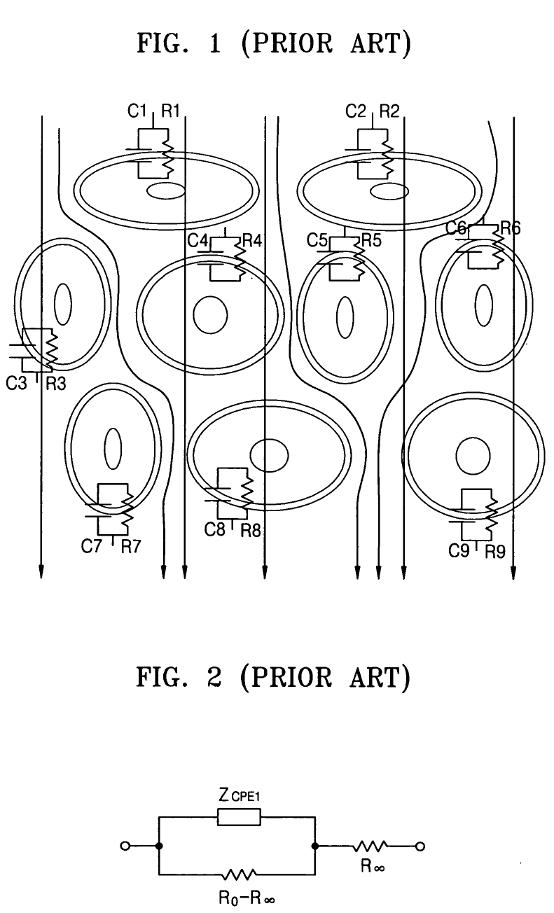

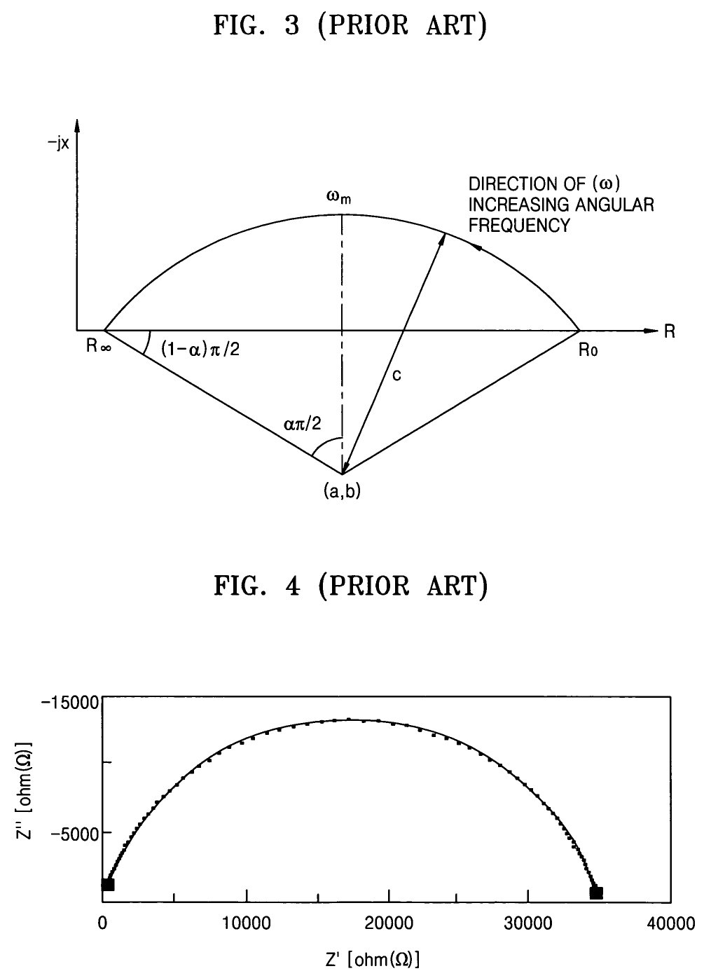

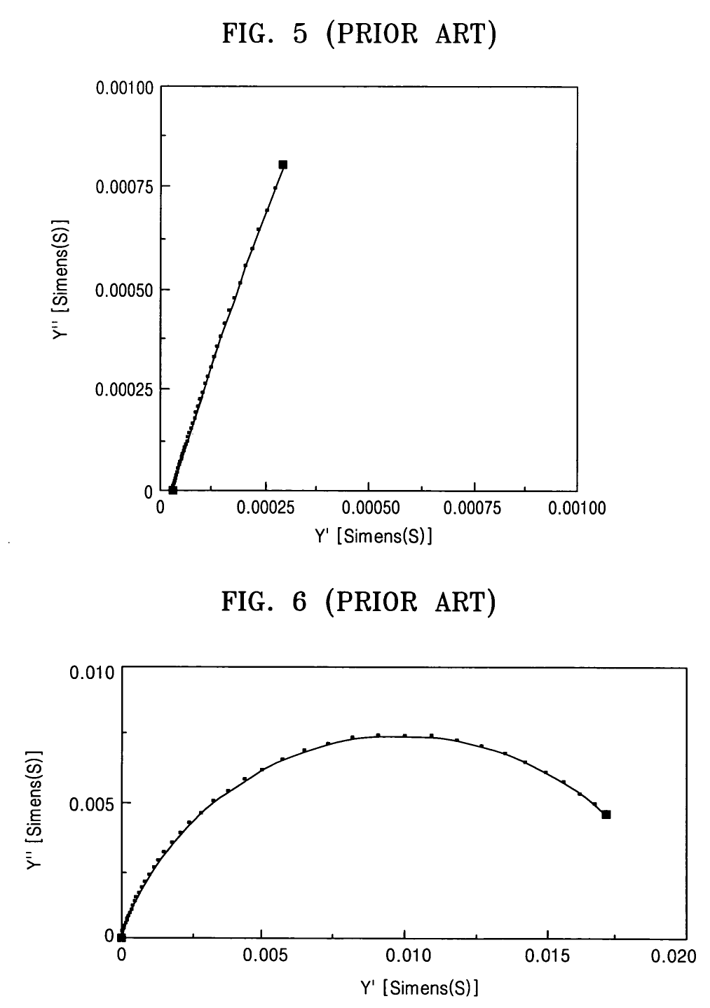

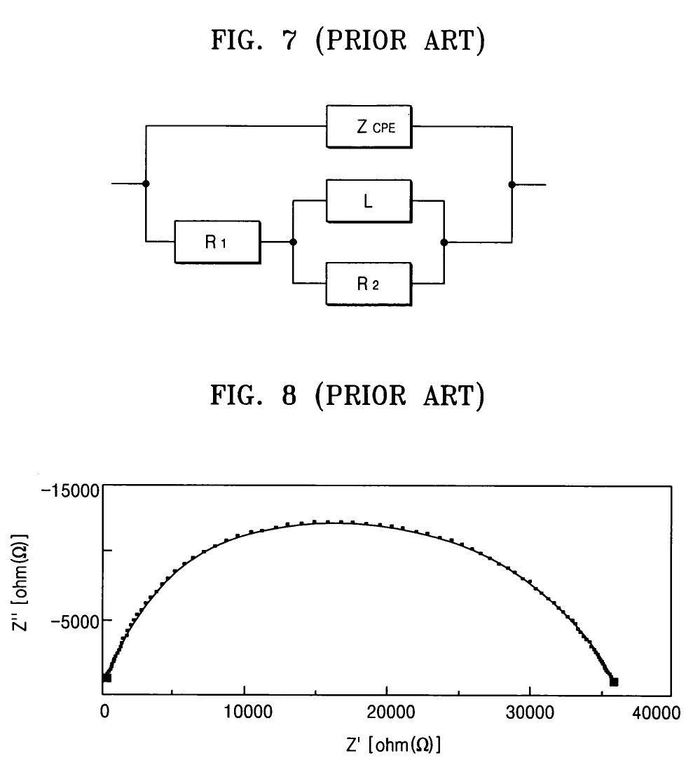

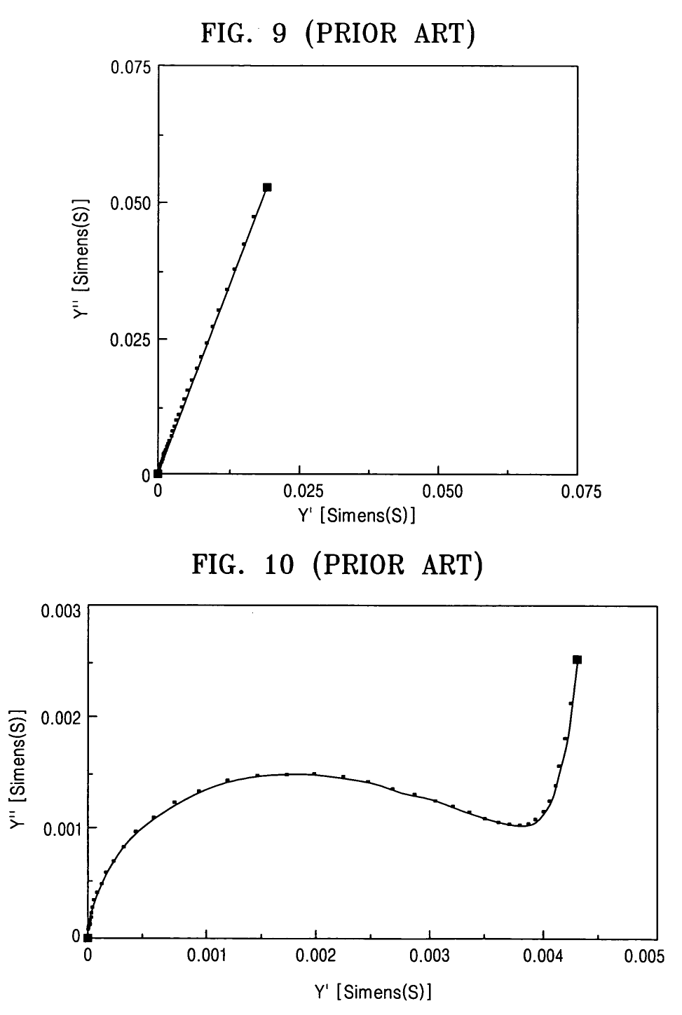

### DETAILED DESCRIPTION OF THE INVENTION

Korean Patent Application No. 2003-81101, filed Nov. 17, 2003, and entitled: “Human Skin Impedance Model Representing a Skin Impedance Response at High Frequency,” is incorporated by reference herein in its entirety.

The present invention will now be described more fully hereinafter with reference to the accompanying drawings, in which preferred embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. Like reference numerals and characters refer to like elements throughout.

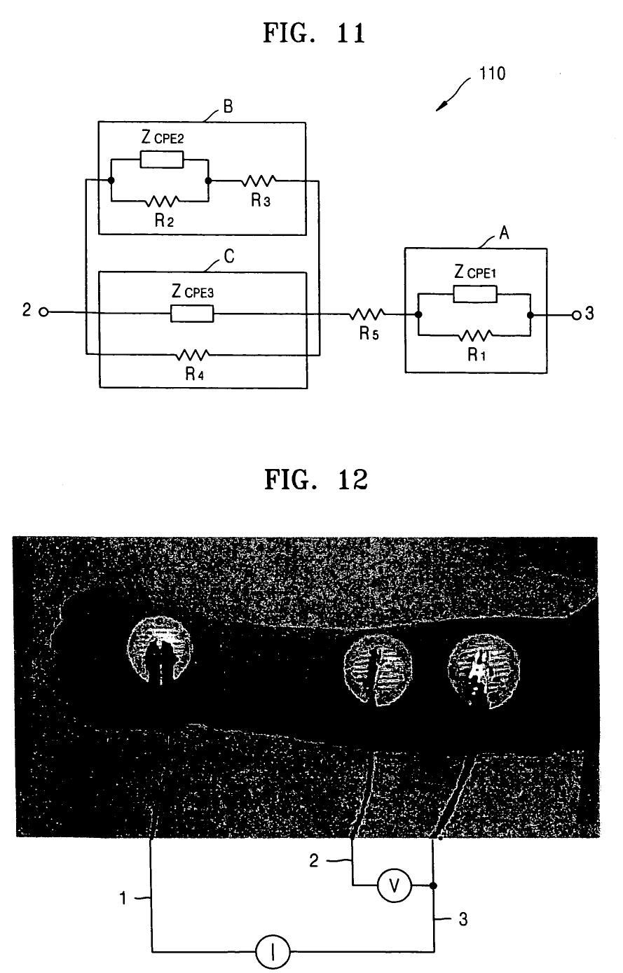

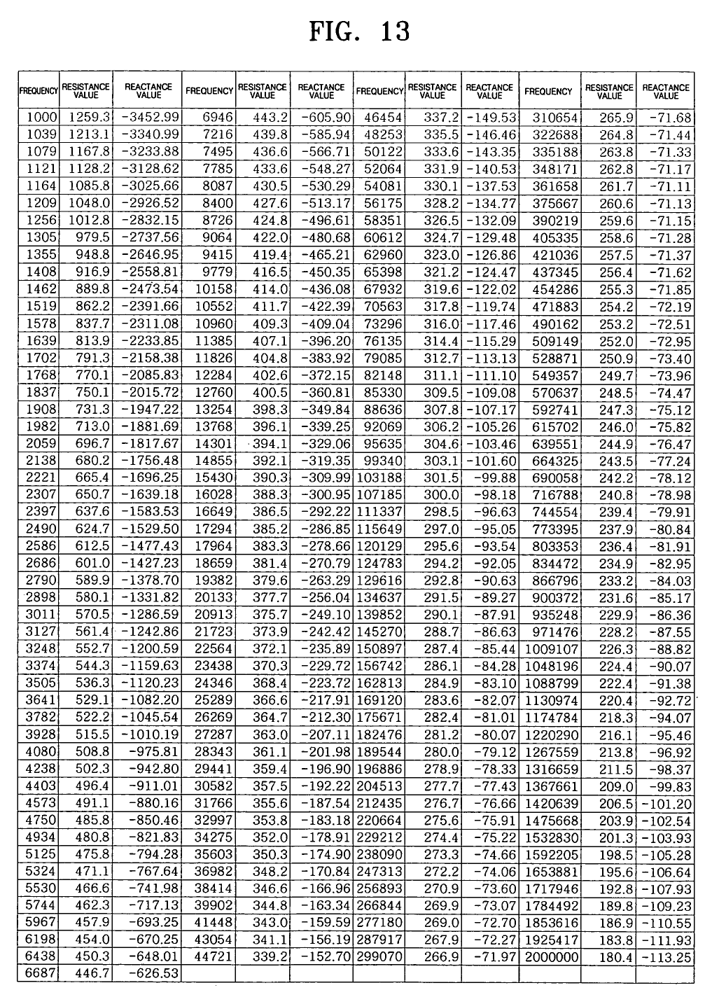

FIG. 11 is a diagram illustrating a skin impedance model according to a first embodiment of the present invention, and is obtained by analyzing skin impedance data measured using a 3-electrode method as illustrated in FIG. 12. In the 3-electrode method, by providing a predetermined current (I) between a first terminal 1 and a third terminal 3, a voltage (V) between a second terminal 2 and the third terminal 3 may be measured. FIG. 13 is a table showing skin impedance data of a forearm part on thirty-six (36) frequency spots at a frequency band from 1 kHz to 2 MHz.

The skin impedance model 110 between second and third terminals 2 and 3 of FIG. 11 obtained from the skin impedance data of FIG. 13 is represented by a first area A, a second area B, and a third area C. The first area A is a portion representing an impedance of outer skin where a first resistor R₁ and a first CPE Z_{CPE1} are connected in parallel. The second area B is a portion representing a membrane and an intercellular fluid in corium constituents of skin, in which a second resistor R₂ and a second CPE Z_{CPE2} are connected in parallel, and then serially connected to a third resistor R₃. The third area C is a portion representing an intercellular fluid in corium constituents of skin, in which a fourth resistor R4 and a third CPE Z_{CPE3} are connected in parallel. The second area B and the third area C are connected in parallel and then serially connected to the first area A through a fifth resistor R₅. This skin impedance model 110 may be expressed as the following equation 4:

$$\begin{matrix}Z = \frac{{R}_{1} {{k}_{1} ( j ω )}^{- α1}}{{R}_{1} + {{k}_{1} ( j ω )}^{- α1}} + \\ \frac{{R}_{2} {R}_{3} {R}_{4} {{k}_{2} ( j ω )}^{- α2} + {R}_{2} ( {R}_{3} + {R}_{4} ) {k}_{2} {{k}_{3} ( j ω )}^{- ( α2 + α3 )}}{\begin{matrix}{R}_{2} {R}_{3} {R}_{4} + ( {R}_{2} {R}_{3} + {R}_{3} {R}_{4} ) {{k}_{2} ( j ω )}^{- α 2} + \\ {R}_{2} ( {R}_{3} + {R}_{4} ) {k}_{2} {{k}_{3} ( j ω )}^{- α 3} + ( {R}_{2} + {R}_{3} + {R}_{4} ) {k}_{2} {{k}_{3} ( j ω )}^{- ( α2 + α3 )}\end{matrix}}\end{matrix} \qquad ( 4 )$$

Parameters and errors applied to the skin impedance model 110 are as shown in Table 1:

TABLE 1

| | | Parameters |
|---|---|---|
| R₄ | | 444.1 |
| Z_{CPE3} | T | 5.0357E−10 |
| | P | 0.94037 |
| R₂ | | 2700 |
| Z_{CPE2} | T | 9.2921E−08 |
| | P | 0.74856 |
| R₃ | | 610.5 |
| R₅ | | 3E−07 |
| R₁ | | 22397 |
| Z_{CPE1} | T | 7.0978E−08 |
| | P | 0.94386 |

| | |
|---|---|
| X² ERROR | 3.954E−6 |

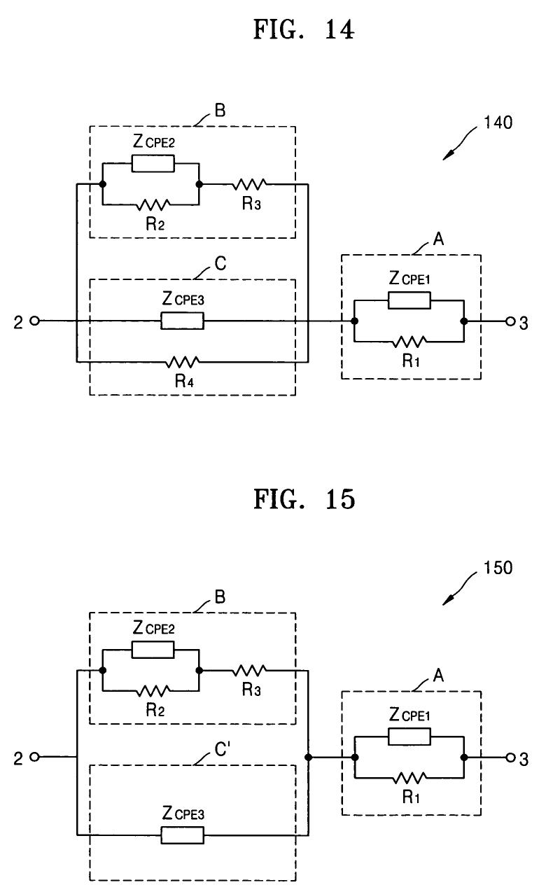

FIG. 14 is a diagram for explaining a skin impedance model according to a second embodiment of the present invention. Referring to FIG. 14, the skin impedance model 140 includes a first area A where a first resistor R₁ is connected to a first CPE Z_{CPE1} in parallel, a second area B where a second resistor R₂ and a second CPE Z_{CPE2} are connected in parallel and then are serially connected to a third resistor R₃, and a third area 3 where a fourth resistor R₄ and a third CPE Z_{CPE3} are connected in parallel. The second area B and the third area C are connected in parallel and then are serially connected to the first area A. The skin impedance model 140 of the second embodiment of the present invention is a simplified model as compared to the model of the first embodiment and may be obtained by removing the fifth resistor R₅ from the skin impedance model 110 according to the first embodiment as shown in FIG. 11.

Parameters and errors applied to the skin impedance model 140 are as shown in Table 2:

TABLE 2

| | | Parameters |
|---|---|---|
| R₄ | | 445 |
| Z_{CPE3} | T | 5.0357E−10 |
| | P | 0.94037 |
| R₂ | | 2651 |
| Z_{CPE2} | T | 9.3456E−08 |
| | P | 0.74856 |
| R₃ | | 608.7 |
| R₁ | | 22397 |
| Z_{CPE1} | T | 7.0978E−08 |
| | P | 0.94386 |

| | |
|---|---|
| X² ERROR | 3.954E−6 |

FIG. 15 is a diagram for explaining a skin impedance model according to a third embodiment of the present invention. Referring to FIG. 15, the skin impedance model 150 includes a first area A where a first resistor R₁ is connected to a first CPE Z_{CPE1} in parallel, a second area B where a second resistor R₂ and a second CPE Z_{CPE2} are connected in parallel and then are serially connected to a third resistor R₃, and a third area C′ having a third CPE Z_{CPE3}. The second area B and the third area C′ are connected in parallel and then are serially connected to the first area A. The skin impedance model 150 of the third embodiment of the present invention is the most simplified model as compared to the models of the first and second embodiments and may be obtained by including the characteristics of the fourth resistor R₄ in the second resistor R₂ and the third resistor R₃ from the skin impedance model 140 according to the second embodiment of the present invention as shown in FIG. 14.

Parameters and errors applied to the skin impedance model 150 are as shown in Table 3:

TABLE 3

| | | Parameters |
|---|---|---|
| Z_{CPE3} | T | 5.0357E−10 |
| | P | 0.94037 |
| R₂ | | 34.5 |
| Z_{CPE2} | T | 5.2404E−07 |
| | P | 0.74856 |
| R₃ | | 257.1 |
| R₁ | | 22397 |
| Z_{CPE1} | T | 7.0978E−08 |
| | P | 0.94386 |

| | |
|---|---|
| X² ERROR | 3.9338E−6 |

Accordingly, it may be seen that in the skin impedance models according to the embodiments of the present invention, small x² errors of about 4E-6 occur and the measured skin impedance data of FIG. 13 are accurately represented.

Preferred embodiments of the present invention have been disclosed herein and, although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

1. A skin impedance model of a predetermined part of a living body, which is an object to be measured, wherein the skin impedance model is estimated by providing a predetermined current between two ends of the predetermined part and measuring a voltage between the two ends, the model comprising:
a first area having a first resistor and a first constant phase element (CPE) connected in parallel;
a second area having a second resistor and a second CPE connected in parallel, and a third resistor serially connected to the parallel connection of the second resistor and the second CPE; and
a third area having a fourth resistor and a third CPE connected in parallel, wherein the second area and the third area are connected in parallel and are serially connected to the first area through a fifth resistor.

2. The skin impedance model as claimed in claim 1, wherein the first area represents an outer skin impedance of the predetermined part.

3. The skin impedance model as claimed in claim 1, wherein the second area represents an impedance of a membrane and an intercellular fluid in corium constituents of the skin of the predetermined part.

4. The skin impedance model as claimed in claim 1, wherein the third area represents an impedance of an intercellular fluid in corium constituents of the skin of the predetermined part.

5. The skin impedance model as claimed in claim 1, wherein the skin impedance model is obtained from data measured in the predetermined part using a 3-electrode method.

6. The skin impedance model as claimed in claim 1, wherein the skin impedance model is expressed as:
$$\begin{matrix}Z = \frac{{R}_{1} {{k}_{1} ( j ω )}^{- α1}}{{R}_{1} + {{k}_{1} ( j ω )}^{- α1}} + \\ \frac{{R}_{2} {R}_{3} {R}_{4} {{k}_{2} ( j ω )}^{- α2} + {R}_{2} ( {R}_{3} + {R}_{4} ) {k}_{2} {{k}_{3} ( j ω )}^{- ( α2 + α3 )}}{\begin{matrix}{R}_{2} {R}_{3} {R}_{4} + ( {R}_{2} {R}_{3} + {R}_{3} {R}_{4} ) {{k}_{2} ( j ω )}^{- α 2} + \\ {R}_{2} ( {R}_{3} + {R}_{4} ) {k}_{2} {{k}_{3} ( j ω )}^{- α 3} + ( {R}_{2} + {R}_{3} + {R}_{4} ) {k}_{2} {{k}_{3} ( j ω )}^{- ( α2 + α3 )}\end{matrix}} .\end{matrix}$$

7. A skin impedance model of a predetermined part of a living body, which is an object to be measured, wherein the skin impedance model is estimated by providing a predetermined current between two ends of the predetermined part and measuring a voltage between the two ends, the model comprising:
a first area having a first resistor and a first constant phase element (CPE) connected in parallel;
a second area having a second resistor and a second CPE connected in parallel, and a third resistor serially connected to the parallel connection of the second resistor and the second CPE; and
a third area having a fourth resistor and a third CPE connected in parallel,
wherein the second area and the third area are connected in parallel and are serially connected to the first area.

8. The skin impedance model as claimed in claim 7, wherein the skin impedance model is obtained from data measured in the predetermined part using a 3-electrode method.

9. The skin impedance model as claimed in claim 7, wherein the skin impedance model is expressed as:
$$\begin{matrix}Z = \frac{{R}_{1} {{k}_{1} ( j ω )}^{- α1}}{{R}_{1} + {{k}_{1} ( j ω )}^{- α1}} + \\ \frac{{R}_{2} {R}_{3} {R}_{4} {{k}_{2} ( j ω )}^{- α2} + {R}_{2} ( {R}_{3} + {R}_{4} ) {k}_{2} {{k}_{3} ( j ω )}^{- ( α2 + α3 )}}{\begin{matrix}{R}_{2} {R}_{3} {R}_{4} + ( {R}_{2} {R}_{3} + {R}_{3} {R}_{4} ) {{k}_{2} ( j ω )}^{- α 2} + \\ {R}_{2} ( {R}_{3} + {R}_{4} ) {k}_{2} {{k}_{3} ( j ω )}^{- α 3} + ( {R}_{2} + {R}_{3} + {R}_{4} ) {k}_{2} {{k}_{3} ( j ω )}^{- ( α2 + α3 )}\end{matrix}} .\end{matrix}$$

10. A skin impedance model of a predetermined part of a living body which is an object to be measured, wherein the skin impedance model is estimated by providing a predetermined current between two ends of the predetermined part and measuring a voltage between the two ends, the model comprising:
a first area having a first resistor and a first constant phase element (CPE) connected in parallel;
a second area having a second resistor and a second CPE connected in parallel, and a third resistor serially connected to the parallel connection of the second resistor and the second CPE; and
a third area having a third CPE,
wherein the second area and the third area are connected in parallel and are serially connected to the first area.

11. The skin impedance model as claimed in claim 10, wherein the skin impedance model is obtained from data measured in the predetermined part using a 3-electrode method.

12. The skin impedance model as claimed in claim 10, wherein the skin impedance model is expressed as:
$$\begin{matrix}Z = \frac{{R}_{1} {{k}_{1} ( j ω )}^{- α1}}{{R}_{1} + {{k}_{1} ( j ω )}^{- α1}} + \\ \frac{{R}_{2} {R}_{3} {R}_{4} {{k}_{2} ( j ω )}^{- α2} + {R}_{2} ( {R}_{3} + {R}_{4} ) {k}_{2} {{k}_{3} ( j ω )}^{- ( α2 + α3 )}}{\begin{matrix}{R}_{2} {R}_{3} {R}_{4} + ( {R}_{2} {R}_{3} + {R}_{3} {R}_{4} ) {{k}_{2} ( j ω )}^{- α 2} + \\ {R}_{2} ( {R}_{3} + {R}_{4} ) {k}_{2} {{k}_{3} ( j ω )}^{- α 3} + ( {R}_{2} + {R}_{3} + {R}_{4} ) {k}_{2} {{k}_{3} ( j ω )}^{- ( α2 + α3 )}\end{matrix}} .\end{matrix}$$

13. A skin impedance model of a predetermined part of a living body, which is an object to be measured, wherein the skin impedance model is estimated by providing a predetermined current between two ends of the predetermined part and measuring a voltage between the two ends, the model comprising:
a first area representing an outer skin impedance of the predetermined part;
a second area representing an impedance of a membrane and an intercellular fluid in corium constituents of the skin of the predetermined part; and
a third area representing an impedance of an intercellular fluid in corium constituents of the skin of the predetermined part,
wherein the second area and third area are connected in parallel and are serially connected to the first area.

14. The skin impedance model as claimed in claim 13, wherein the first area has a first resistor and a first constant phase element (CPE) connected in parallel, the second area has a second resistor and a second CPE connected in parallel, and a third resistor serially connected to the parallel connection of the second resistor and the second CPE, and the third area has a fourth resistor and a third CPE connected in parallel, and wherein the second area and the third area are serially connected to the first area through a fifth resistor.

15. The skin impedance model as claimed in claim 13, wherein the first area has a first resistor and a first constant phase element (CPE)-connected in parallel, the second area has a second resistor and a second CPE connected in parallel, and a third resistor serially connected to the parallel connection of the second resistor and the second CPE, and the third area has a fourth resistor and a third CPE connected in parallel.

16. The skin impedance model as claimed in claim 13, wherein the first area has a first resistor and a first constant phase element (CPE) connected in parallel, the second area has a second resistor and a second CPE connected in parallel, and a third resistor serially connected to the parallel connection of the second resistor and the second CPE, and the third area has a third CPE.

17. The skin impedance model as claimed in claim 13, wherein the skin impedance model is obtained from data measured in the predetermined part using a 3-electrode method.

18. The skin impedance model as claimed in claim 13, wherein the skin impedance model is expressed as:
$$\begin{matrix}Z = \frac{{R}_{1} {{k}_{1} ( j ω )}^{- α1}}{{R}_{1} + {{k}_{1} ( j ω )}^{- α1}} + \\ \frac{{R}_{2} {R}_{3} {R}_{4} {{k}_{2} ( j ω )}^{- α2} + {R}_{2} ( {R}_{3} + {R}_{4} ) {k}_{2} {{k}_{3} ( j ω )}^{- ( α2 + α3 )}}{\begin{matrix}{R}_{2} {R}_{3} {R}_{4} + ( {R}_{2} {R}_{3} + {R}_{3} {R}_{4} ) {{k}_{2} ( j ω )}^{- α 2} + \\ {R}_{2} ( {R}_{3} + {R}_{4} ) {k}_{2} {{k}_{3} ( j ω )}^{- α 3} + ( {R}_{2} + {R}_{3} + {R}_{4} ) {k}_{2} {{k}_{3} ( j ω )}^{- ( α2 + α3 )}\end{matrix}} .\end{matrix}$$
